(19) United States
(12) Patent Application Publication
(10) Pub. No.: US 2024/0204436 A1
(43) Pub. Date: Jun. 20, 2024

(54) CONNECTOR ELEMENT FOR A CONNECTOR SYSTEM

(71) Applicant: Mettler-Toledo GmbH, Greifensee (CH)

(72) Inventor: Thierry Oppliger, Greifensee (CH)

(21) Appl. No.: 18/536,361

(22) Filed: Dec. 12, 2023

(30) Foreign Application Priority Data
Dec. 16, 2022 (EP) 22214299.4

(51) Int. Cl. H01R 13/11; H01R 12/72; H01R 13/42

(52) U.S. Cl. CPC H01R 13/11; H01R 12/721; H01R 13/42; H01R 2201/20

(57) ABSTRACT

A connector element for a connector system includes at least three contact members for making electric contact and a contact member carrier. The contact member carrier has a front face. The contact members extend through the contact member carrier from the front face to a back face on a back side of the contact member carrier and project from the back side. Each contact member has an insulation radius being, when measured in a view onto the front face, a minimum clearance between the outer boundaries of said contact member and the closest neighboring contact member. The insulation radius of at least one of the contact members exceeds the insulation radius of another one of the contact members.

### CROSS-REFERENCE TO RELATED APPLICATIONS

This application claims the benefit of European Patent Application No. EP 22214299.4 filed Dec. 16, 2022, the disclosure of which are hereby incorporated by reference as if fully restated herein.

### TECHNICAL FIELD

Exemplary embodiments relate generally to a connector element for a connector system, such as for electronic signalling, and related systems and methods.

### BACKGROUND AND SUMMARY OF THE INVENTION

In numerous technical applications sensors are used in combination with sensor heads, which in turn comprise electronic components for processing signals received from the sensor. As sensors are typically subject to wear, the electronic components arranged in the sensor head were in the prior art usually reduced to the function of receiving and transmitting the signals, while more complex functions such as an analog to digital conversion were done in a meter or terminal, arranged in a distance from the sensor, which would receive the signals form the senor head. As digital signals are less prone to be disturbed during transmission, it would be desirable to allow a conversion of the analog signal in a digital signal or similar more complex functions, such as applying a calibration to the signal, closer to the sensor. One specific example is the determination of the pH value of a liquid, in which signals from the pH sensor may be processed and digitized in the sensor head. It may appear that a sensor is worn or otherwise damaged, while the sensor head is still working well. In such a case it may be desirable to replace the sensor alone, while continuing use of the sensor head. It may appear, in other instances, that a different sensor type is required for a specific application, in which case it may also be found desirable to replace the sensor only.

It may thus be found desirable that a releasable connection is provided between the sensor and the sensor head. For instance, a plug-and-socket connector system may be implemented between the sensor and the sensor head. In an aspect, it may be desirable if replacement of the sensor can be performed by a user or a service technician in the field, while avoiding the risk of installing the sensor with wrongly paired contact members of the sensor and the sensor head. In another aspect, it may be desirable to yield a sufficient electric resistance between the contact members transmitting relatively weak analog measurement signals from the sensor, so as to minimize distortions of the measurement signals due to creeping currents on a connector interface between contact members. It must be considered in this respect that the size of the connectors cannot be increased at will, but is subject to constraints.

It is understood that the desire for connector elements and connector systems yielding characteristics mentioned above may be present in other technical fields.

An appliance for connecting a pH sensor to an electronic device is described for instance in DE 10 2012 109 497 A1. Other exemplary plug-and-socket connector systems are disclosed in U.S. Pat. No. 10,096,916 B1, CN 213093506 U and US 2007/0217179 A1.

It is an object of the present disclosure to provide the above-described subject matter. In a more specific aspect, a connector element for a connector system, in particular for transmitting electric power and signals, shall be provided. In more specific aspects, said connector element, and the connector system in which it is used, shall yield certain desirable characteristics outlined above.

This is achieved by the subject matter set forth in the claims.

Further effects and advantages of the disclosed subject matter, whether explicitly mentioned or not, will become apparent in view of the disclosure provided below.

Accordingly, disclosed is a connector element for a connector system. The connector element comprises at least three contact members for making electric contact with a counterpart contact member in a matching counterpart connector element, and a contact member carrier. The contact member carrier has a front face. More specifically, the front face is a face where the contact members are accessible for making contact with counterpart contact members. Further, the contact members extend, in particular parallel to each other, through the contact member carrier from the front face to a back face on a back side of the contact member carrier, opposite the front face, and project from the back side. The terms “projecting sections” and “contact member projecting sections” and similar terms as used hereinafter shall be understood essentially as the sections of the contact members which project from the back face of the contact member carrier. Each contact member has an insulation radius when measured in a view onto the front face. The insulation radius is measured as a minimum clearance between the outer boundaries of said contact member and the closest neighbouring contact member. It is understood that said insulation radius is in particular measured in a top or plain view onto the front face. At least one of the contact members has an insulation radius which exceeds the insulation radius of another contact member.

In more particular embodiments, it may be provided that exactly one contact member has an insulation radius exceeding the insulation radius of any other contact member. It may moreover be provided, in these particular embodiments, that all other contact members have the same insulation radius which is smaller than that of the one specific contact member having an insulation radius exceeding the insulation radius of any other contact member.

By virtue of at least one contact member having an increased insulation radius compared to other contact members the signals transmitted by said at least one contact member are less sensitive to creeping currents and other confounding effects compared to other contact members having smaller insulation radii. Thus, confounding effects on sensitive signals in the connector element can be largely reduced, while still dimensional constraints are taken into account in that other contact members are still arranged with smaller insulation radii, i.e., in a more compact arrangement. The minimum insulation resistance of the at least on contact member having an increased insulation radius compared to other contact members may by 10 TQ or more.

Preferably, instead of “insulation radius” the term “minimum insulation distance can be used. The minimum insulation distance is measured as a minimum clearance between the outer boundaries of said contact member and the closest neighbouring contact member. It is understood that said insulation distance is in particular measured in a top or plain view onto the front face.

The contact member carrier may in particular be made of a plastic with a high insulation resistance. Preferably, the high insulation resistance is greater or equal to 10¹⁴ (Ω/cm. This allows to obtain the desired electrical properties even at small insulation radii such as radii between 1 and 2 mm. Preferably, the plastic is injection mouldable. This facilitates the production of the connector element. Preferably, the plastic has a water absorption of less or equal to 0.4% and can be used at temperatures between −40° C. and +85° C. With these properties, the connector element can be used reliably in a surrounding where it might get wet and at all temperatures at which sensors and chains transmitting signals from these sensors are typically used. Preferably, the plastic is therefore one of the following: PBT, PEEK, PPE, PPS, LCP or a fluoroplastic such as PCTFE, PVDF, ECTFE, ETFE, PFA or FEP.

It is noted that within the framework of the present disclosure the use of the indefinite article “a” or “an” does in no way stipulate a singularity nor does it exclude the presence of a multitude of the named member or feature. It is thus to be read in the sense of “at least one” or “one or a multitude of”.

It is moreover noted that in the context of the present application the terms “bordering” and “adjacent” as well as “bordering” and “adjacent to” are considered as synonyms.

The contact member carrier may in embodiments comprise at least one of collars extending from the back face and surrounding the projecting sections of the contact members projecting from the back face along a part of their longitudinal extents, and/or recesses surrounding the projecting sections of the contact members. These features may serve to further increase the creepage distance for electrical currents and thus reduce such creeping currents between neighbouring contact members on the back face of the contact member carrier.

The contact members may be arranged in two arrays extending across the front face. In more particular embodiments, these arrays may be straight and/or parallel to each other.

In a preferred embodiment, the distance between two arrays which are parallel to each other or a clear space between the two arrays is between 1 mm and 1.2 mm, more preferably between 1.05 mm and 1.1 mm. In another preferred embodiment, the distance between two arrays which are parallel to each other is between 1.6 mm and 1.95 mm, more preferably 1.65 mm and 1.8 mm. These specific choices allow to arrange a printed circuit board (PCB) between projecting sections of the contact members. As will be explained in the following, using projecting sections of the contact members to support the PCB facilitates connecting a PCB to the connector element and makes the connection more robust.

In further aspects of the disclosed subject matter there is disclosed an assembly comprising a connector element of any type outlined above and a printed circuit board. The printed circuit board is received between the contact member projecting sections projecting from the back face. At least one contact member projecting section is located on each face of the printed circuit board and directly soldered to a conductor path of the printed circuit board, thus electrically connecting the at least one contact member to the conductor path. In particular, all of said projecting sections may be directly soldered to a respective conductor path of the printed circuit board. To enable this, the printed circuit board may be received between the contact member projecting sections projecting from the back face in a fit. In embodiments, the closest distance between tangents of two of said projecting sections, which tangents are parallel to the surfaces of the printed circuit board, and measured perpendicular to the surfaces of the printed circuit board, may correspond to more than or equal to one times the thickness of the printed circuit board and less than or equal to 1.2 times the thickness of the printed circuit board, and may in even more particular embodiments correspond to more than or equal to 1.05 times the thickness of the printed circuit board and less than or equal to 1.1 times the thickness of the printed circuit board. Due to the resulting proximity of the contact member projecting sections projecting from the back face to the surface of the printed circuit board, it is enabled that the contact member projecting sections projecting from the back face of the contact member carrier are directly soldered to respective conductor paths on the printed circuit board. Most preferably, the thickness of the PCB is 1 mm, as this allows a compact assembly which has still the desired electrical properties. In another embodiment, the PCB has a thickness of 1.6 mm.

In case the connector elements are arranged in two arrays, it may be provided that a clear space is provided between the projecting sections projecting from the back face of the contact member carrier of the contact members of the first array and the contact members of the second array, wherein the printed circuit board is arranged inside and extends, at least essentially, across the clear space from the projecting sections of the contact members of the first array to the projecting sections of the contact members of the second array. It may in particular be provided that the boundaries of the projecting sections of the contact members in the first array have a common tangential plane facing the projecting sections of the contact members in the second array and the boundaries of the projecting sections of the contact members in the second array have a common tangential plane facing the projecting sections of the contact members in the first array. The distance between the two tangential planes of the boundaries of the projecting sections of the contact members may in particular correspond to more than or equal to one times the thickness of the printed circuit board and less than or equal to 1.2 times the thickness of the printed circuit board, and may in even more particular embodiments correspond to more than or equal to 1.05 times the thickness of the printed circuit board and less than or equal to 1.1 times the thickness of the printed circuit board.

It is understood that, as the arrangement of the connector elements and thus of the projecting sections of the contact members, is generally non-symmetric, the conductor paths on the printed circuit board which are intended for being brought in contact with the projecting sections of the contact members and said projecting sections themselves can only be brought into registry in one single relative orientation of the projecting sections of the contact members and the printed circuit board. It is thus essentially not possible to connect a contact member to a wrong conductor path by mistake and without noticing it.

In further aspects, a recess may be provided on the back side of the contact member carrier and configured to receive the printed circuit board, or an end section thereof, respectively. There could also be multiple recesses which are configured to receive an end section of the printed circuit board or protruding features of the printed circuit board therein.

The printed circuit board may have at least one contact path intended for transmitting an analog measurement signal to or from at least one circuit component arranged on the printed circuit board, wherein one of: at least one of the at least one contact members having an insulation radius which exceeds the insulation radius of another contact member and/or the one contact member having an insulation radius exceeding the insulation radius of any other contact member is in electric contact with at least one of the at least one contact paths intended for transmitting an analog measurement signal to or from at least one circuit component. These embodiments take advantage of the benefits of the above-described connector element, as the analog signal which is transmitted through a contact member having an increased insulation radius is less exposed to interferences from other contact members.

In still a further aspect, an electronic device is disclosed which comprises an assembly as set forth above, wherein a pluggable connector is attached to the printed circuit board opposite the connector element of the assembly. The electronic device further comprises a housing extending between the connector element and the pluggable connector and encapsulating the printed circuit board.

Preferably, the housing is cylindrical with an outer diameter of less or equal 1.5, preferably less or equal to 1.25 times and most preferably greater or equal to 1 times, the diameter of the shaft of the sensor. Preferable, the housing is cylindrical with an outer diameter of less or equal to 18 mm, preferably less or equal to 15 mm and most preferable greater or equal to 12 mm. Sensors, such as pH-sensors, conductivity sensors, ion-selective electrodes to measure ion concentrations, sensors to determine dissolved oxygen, turbidity and/or oxidation reduction potential comprise typically a shaft with a diameter of 12 mm. A housing with an outer diameter which is equal to or slightly greater than the sensor ensures that the combination of sensor shaft and electronic device is handy and convenient to store and to mount. The housing with such dimensions does not distract the view on the sensor shaft and allows the use of sensor holding devices designed for sensors without an electronic device according to the invention.

In yet a further aspect, a sensor assembly is disclosed. The sensor assembly comprises a sensor and a connector element of the kind outlined above. A signal line of the sensor through which an analog measurement signal is provided is in electrical connection with: one of the at least one contact members having an insulation radius which exceeds the insulation radius of another contact member or the one contact member which has an insulation radius exceeding the insulation radius of any other contact member.

A connector element which is particular well suited for this embodiment comprises a mounting structure for the sensor. The mounting structure 133 provides a surface to which the sensor can be mounted, for example by an adhesive. Preferably, the mounting structure is a hollow cylinder. In a particular embodiment, the mounting structure comprises an inner shoulder at the end facing the projecting sections of the contact members of the connector element. The mounting structure can either be mechanically connected to the contact member carrier or it is a part of it. In a preferred embodiment the mounting structure is part of the contact member carrier.

In a further preferred embodiment of such a connector element, the contact member carrier comprises windows which allow to access the projecting sections of the contact members. Preferably, if the contact members are arranged in two arrays, the windows are such that the contact members can be accessed from a direction perpendicular to the extent of the array. Preferably, the projecting sections of the contact members are shaped as half-pipes, with the open side pointing towards the respective window. This facilitates making connections thereto by soldering.

Preferably, the connector element comprises further a connector element housing. In this embodiment, it is preferred that a mounting structure comprises further an outer shoulder. The outer shoulder and the connector element housing are designed such that the connector element housing can be pushed over the contact member carrier with the mounting structure until it abuts the outer shoulder of the mounting structure. This facilitated the assembly.

During production, the sensor can be mounted to the contact member carrier by pushing it into the mounting structure until it reaches the inner shoulder. The sensor can be fixed in this position with an adhesive or other known means. Once this mechanical connection is established, the electrical connections between the sensor and the contact members is established, for example by soldering, whereby the windows allow the necessary access to the projecting sections of the contact members. Once the mechanical and electrical connections are established, the connector element housing is mounted by pushing it over the contact member carrier until it abuts the outer shoulder of the mounting structure. Thereby, the connector element housing covers the windows. Further, the mechanical connection of the sensor to the mounting structure reduced the mechanical stress on the electrical connections during assembly and during use.

In a more specific, while non-limiting, embodiment, the connection element is a connection element in which exactly one contact member has an insulation radius exceeding the insulation radius of any other contact member. The sensor is in this embodiment a pH-sensor comprising a pH measurement electrode for providing a signal caused by a measured solution, a pH reference electrode for providing a signal caused by a reference electrolyte, and a thermocouple. The pH measurement electrode is connected to the one contact member which has an insulation radius exceeding the insulation radius of any other contact member, and further contact members are in connection with the reference electrode, a grounding connection, and the thermocouple.

In further embodiments, the sensor of the sensor assembly is a conductivity sensor, an ion-selective electrode to measure ion concentrations, a sensor to determine dissolved oxygen, turbidity and/or oxidation reduction potential.

A connector system in line with the scope of the present disclosure comprises two connector elements of the kind outlined above. A first one of the connector elements comprises contact members comprising one of: at least one pin-type contact member extending from the front face, at least one socket-type contact member comprising a socket accessible from the front face, or a combination thereof, while a second one of the connector elements comprises contact members which are arranged on the front face of the contact member carrier of the second connector element and which are shaped and arranged complementary to the contact members of the first connector element, so that the contact members of the first and second connector element can be engaged with each other. In particular, the arrangement of contact members, when looking onto the front face of the respective contact member carriers, may be mirrored in the second connector element compared with the first connector element. Further, one socket type contact member is arranged and configure to be matched with each pin-type contact member.

In exemplary embodiments of the connector system, the contact member carrier of a first one of the connector elements comprises a plug structure, wherein the front face is provided on the plug structure, while the contact member carrier of a second one of the connector elements comprises a socket, wherein the front face is recessed within the socket. The plug structure and the socket have complementary cross sections such that the plug structure is receivable inside the socket. The plug structure and the socket are configured to provide a sealing arrangement with each other when the plug structure is received inside the socket. In particular, the outer geometry of the plug structure and/or the inner geometry of the socket are provided without a draft angle. Contact between the contact members of the first connector elements and the contact members of the second connector element is established when the plug structure is received within the socket.

The plug structure may, in exemplary embodiments, comprise at least one coding structure on its outer circumference and the socket comprise at least one coding structure on its inner circumference. The coding structures comprise projecting and recessed coding structures, wherein the recessed coding structures are recessed extending axially on the circumference of at least one of the plug structure and the socket. A matching recessed coding structure needs to be provided for each projecting coding structure to receive the projecting coding structure therein. The skilled person will understand that a projecting coding structure projects form the surface of the plug structure or the socket, and a recessed coding structure is a recess provided in the surface of the plug structure or the socket. Said coding structures of the socket and the plug are configured such that a projecting coding structure on one of the plug structure and the socket is received within a recessed coding structure in the other one of the plug structure and the socket when the plug structure is received within the socket in an orientation in which the complementary contact members of the first and second connector elements match each other. In particular embodiments, the at least one pair of complementary coding structures may be arranged and configured such that the plug structure can only be received within the socket in an orientation in which the complementary contact members of the first and second connector elements match each other. Said effect may be achieved in that the arrangement of the coding structures is non-symmetric along the circumference of the plug and the socket, respectively. The non-symmetry may be achieved for instance through non-symmetric distribution along the circumference, geometry of the coding members, or a combination thereof.

Also disclosed is a method for manufacturing an electronic device of the kind outlined above. The method comprises providing a printed circuit board and providing a connector element according of any kind outlined above. The projecting sections of the contact members are arranged in two rows leaving a clear space between the rows, wherein the clear space is configured and dimensioned to receive the printed circuit board therein with the projecting sections adjacent the two faces of the printed circuit board. The method comprises inserting a first end of the printed circuit board into the clear space such that the projecting sections are in registry with conductor paths of the printed circuit board and directly soldering the projecting sections to the respective conductor paths with which they are in registry. One of a pluggable connector and a sensor are connected to a second end of the printed circuit board. A first one of the members connected to the printed circuit board, i.e., a connector element and a pluggable connector or a connector element and a sensor, comprises a cylindrical outer diameter and a sealing member arranged on the cylindrical outer diameter, and a second one of the members connected to the printed circuit board comprises an end stop for a housing. A housing is provided comprising a cylindrical inner diameter dimensioned to achieve sealing with the sealing member provided on the first one of the members connected to the printed circuit board. Further, the method comprises axially displacing the housing over the first one of the members connected to the printed circuit board towards the second one of the members connected to the printed circuit board until the housing engages the end stop, and, in particular, sealing is achieved between the sealing member and the cylindrical inner diameter section of the housing dimensioned to achieve sealing with the sealing member.

Preferably, a connector system according to the invention comprises an electromagnetic compatibility (EMC) shielding. This protects the analog signals transmitted via the connector system from distortion from the surrounding. Most preferably, the EMC shielding is realised by arranging the contact member carriers in a connector element housing comprising, preferably being made of, an electrically conducting material such as metal. One of the contact member carriers is comprises a receiving structure for a locking sleeve while the locking sleeve is mounted to the other contact member carrier. Preferably, the receiving structure for the locking sleeve is a thread while the locking sleeve is mounted to the other contact member carrier by an abutment member comprising a shoulder to which the locking sleeve, comprising a suitable thread and shoulder, abuts when the connection is established and locked. The locking sleeve, and if present, the abutment member, are comprise or are made of an electrically conducting material such as a metal. Thereby, the connector element housings are electrically connected with each other by the locking sleeve, forming a cylindric shield which surrounds the contact members and thereby establishes an EMC protection.

Preferably, an O-Ring is arranged between the contact member carrier and the connector element housing. Thereby a fluid tight sealing is established between the two parts.

In a preferred embodiment, the connector element housing of the connector element to be connected to the PCB comprises axially extending lugs on the side intended to be connected to the PCB. These lugs are arranged in such a way that the PCB can be received between them and can preferable be soldered directly to at least some of them. Thereby, the PCB can provide a common ground to the connector element housing. In addition, the lugs can help to support and align the PCB. To align the lugs of the connector element housing with the contact members, the contact member carrier and the connector element housing are preferably equipped with a coding. The coding is preferably realised by a radial lug of the contact member carrier which corresponds to a matching radial groove of the connector element housing.

Preferably, the EMC shielding is continued to surround the PCB. Most preferably, this is archived by providing an electrically conducting inner tube or coating, which is arranged on the inside of the housing surrounding the PCB. This housing is in this embodiment mounted to the connector element housing of the connector element connected to the PCB by pushing it onto it. The connector element housing of this embodiment comprises a second shoulder onto which the electrically conducting tube or coating abuts in the assembled state and in addition preferably a radial contact surface, along which the housing is pushed during the mounting. Preferably, the housing surrounding the PCB comprises further an outer tube or coating made of electrically insulating material. Preferably, the extent of this outer tube or coating is such that it surrounds the second shoulder of the connector element housing in radial direction when the inner tube or coating abuts to the second shoulder in axial direction. The abutment as well as preferably a contact to the radial contact surface of the connector element housing, established an electrical connection between the connector element housing and the inner tube or coating and therefore extends the EMC shield. The use of a metal tube as inner tube of the housing increases further the mechanical stability of the device.

It is understood that the features and embodiments disclosed above may be combined with each other. It will further be appreciated that further embodiments are conceivable within the scope of the present disclosure and the claimed subject matter which are obvious and apparent to the skilled person by virtue of the present disclosure.

### BRIEF DESCRIPTION OF THE DRAWINGS

The subject matter of the present disclosure is now to be explained in more detail by means of selected exemplary embodiments shown in the accompanying drawings. It is understood that the drawings are highly schematic, and details not required for instruction purposes may have been omitted for the ease of understanding and depiction. It is further understood that the drawings show only selected, illustrative embodiments, and embodiments not shown may still be well within the scope of the herein disclosed and/or claimed subject matter.

The figures show:

FIG. 1 a device in which the herein described subject matter may beneficially be used;

FIG. 2 a first exemplary embodiment of a connector element in a perspective view onto its front face;

FIG. 3 the first exemplary embodiment a connector element in a plain view onto the front face;

FIG. 4 the first exemplary embodiment in a perspective view from a rear side;

FIG. 5A partial view of an electronic device comprising the first exemplary embodiment of a connector element in a longitudinal section;

FIG. 6 a detail of the first exemplary embodiment of a connector element in a sectional view;

FIG. 7 an electronic device comprising the first exemplary embodiment of a connector element with the housing removed in a perspective view;

FIG. 8 a second exemplary embodiment of a connector element in a perspective view onto its front face;

FIG. 9 the second exemplary embodiment a connector element in a plain view onto the front face

FIG. 10 a partial view of a sensor assembly comprising the first exemplary embodiment of a connector element in a longitudinal section;

FIG. 11 the second exemplary embodiment in a perspective view from a rear side; and

FIG. 12 a connector system comprising two exemplary embodiments of connector systems.

### DETAILED DESCRIPTION OF EXEMPLARY EMBODIMENT(S)

It is understood that the following explanations are based upon exemplary and illustrative embodiments, and shall enable a better appreciation of the herein described subject matter. It is understood that in embodiments in which the contact members are provided as sockets, they may be replaced with pin-shaped contact members. Likewise, in embodiments shown with pin-shaped contact members the pin-shaped contact members may be replaced with socket-shaped contact members. Moreover, in one connector element there may be present socket-shaped contact members as well as pin-shaped contact members. For a functioning connector system, it is, however, important that for each pin-shaped contact member of the connector element there is a matching socket-shaped contact member on the counterpart connector element. It will moreover be beneficial if pin-shaped contact members are provided inside a socket to protect them from damage.

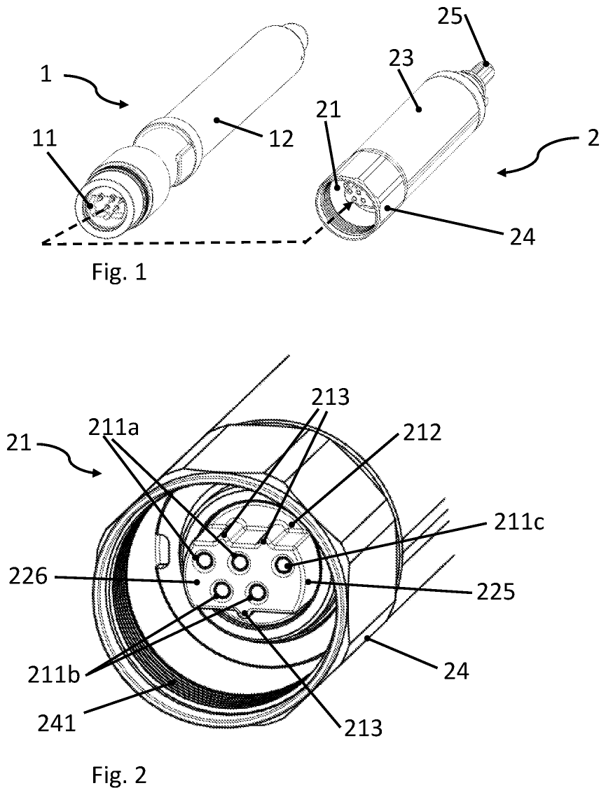

FIG. 1 depicts, as one exemplary device which can make use of the benefits of the herein disclosed subject matter, a pH sensor assembly 1 comprising a sensor 12, and a sensor head 2. The sensor head 2 may generally be defined and described as a device configured to receive measurement signals from a sensor and process the measurement signals. For one instance, the sensor head may be configured to convert an analog measurement signal from the sensor to a digital value. The sensor may be subject to wear and degradation, which may require to replace the sensor while the sensor head is still working probably. However, it might in other instances be that the sensor head has a malfunction while the sensor is still working properly.

It might thus be desirable that the sensor assembly and the sensor head may be divided from each other and replaced independent from each other as needed. It is desirable if this maintenance operation can be performed by a user or a service technician in the field. Sensor assembly 1 comprises sensor 12 and a connector element 11 attached thereto. Sensor head 2 comprises connector element 21 which is configured to match with connector element 11 of the sensor assembly, a housing 23 enclosing the processing electronics, and a further pluggable connector 25 on a second end of sensor head 2, opposite connector element 21. Moreover, a locking sleeve 24 is provided surrounding connector element 21 and is configured to provide a form-lock connection with sensor assembly 1.

Requirements for a plug-and-socket connector system for releasably coupling a sensor to a sensor head include, while not limited to, avoiding or at least reducing parasitic errors at the junction of the two co-operating connector elements and a shape which prevents joining contact members wrongly. In other words, the shape shall guarantee that the connector elements can only be joined to each other in one relative position relative to each other to guarantee that the contact members are matched correctly. Other requirements may include sealing the connector system, so that no liquid can enter the junction of the two co-operating connector elements. Other requirements, whether explicitly mentioned or not, may become apparent from the following description.

Connector element 21 of the sensor head is shown in more detail in FIG. 2, which shows a perspective view onto front face 226 of connector element 21. Connector element 21 comprises contact members 211a, 211b and 211c. In the shown exemplary embodiment all contact members are socket-shaped at front face 226 of connector element 21. However, as outlined above, the contact members or some of the contact members may be pin-shaped and project from the front face 226, and may be configured to mate with socket-shaped contact members of a counterpart connector element. Contact members 211a, 211b and 211c are received in a contact member carrier 212. As will be explained below, the contact members extend through the contact member carrier and project from a back side of the contact member carrier with respective projecting sections of the contact members. These shall be outlined below. Contact member carrier 212 comprises a plug structure 225 on which front face 226 is provided. On the outer circumference of plug structure 225, coding structures 213 are provided. As will become readily apparent, a counterpart connector element comprises a socket structure adapted and configured to receive plug structure 225 therein. Counterpart coding structures are then provided on the inner circumference of the socket structure and are configured for receiving coding structures 213 therein. By virtue of the pairs of coding structures provided on plug structure 225 on in the counterpart socket, it may be provided that plug structure 225 may only be received within the counterpart socket in one single orientation relative to each other, in which the contact members of the connector elements are joined to the correct counterpart connector element. It is thus guaranteed that each signal originating, for example, from sensor assembly 1 is received by and transmitted to the correct terminal of sensor head 2. Locking sleeve 24 comprises internal threat 241.

It shall be understood that the connector element, as defined by the claims, essentially comprises the contact member carrier and the contact members, while further elements shown in FIG. 1, like the locking sleeve or a connector element housing, are optional features which may add functionality.

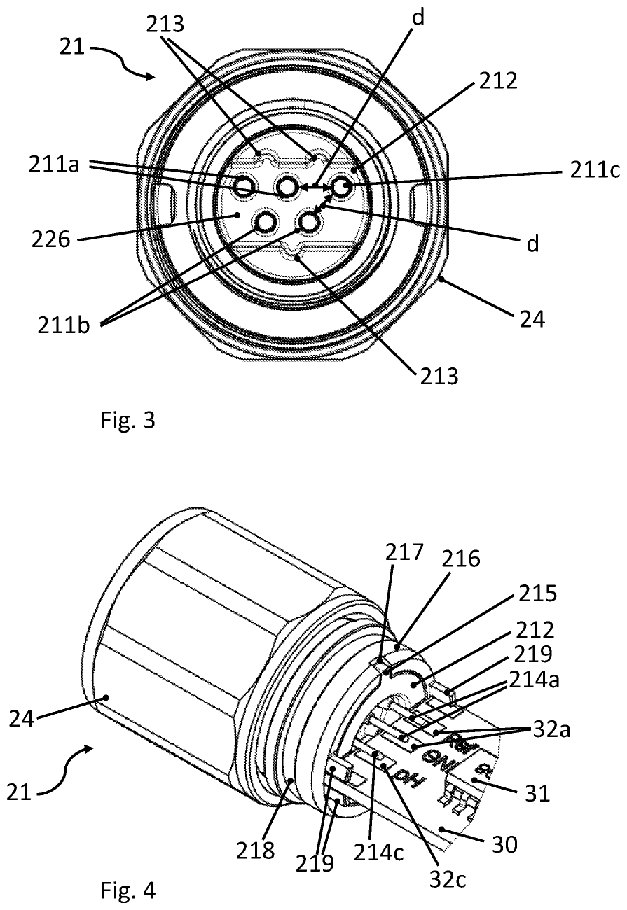

The plain view onto front face 226 illustrated in FIG. 3 illustrates the arrangement of contact members on the front face. Each contact member 211a, 211b and 211c has a minimum clearance between its outer circumference or, more generally spoken, outer boundaries, and the outer boundaries of a closest neighbouring contact member. Said minimum clearance is referred to as the insulation radius of a contact member. As is seen, contact member 211c has an insulation radius d which exceeds the insulation radius of any other contact member. In that the insulation radius of contact members 211a and 211b is smaller than the insulation radius of contact member 211c, the connector element can be maintained relatively small, while the minimum insulation resistance between contact member 211c and any other contact member is higher than that between the other contact members. The person having skill in the art will appreciate that said minimum insulation resistance is dependent on the material used for the contact member carrier, but also dependent on the insulation radius of contact member 211c. A high-quality plastic material having low conductivity may be used for the contact member carrier. However, creeping currents on the surface of the conduct member carrier cannot be influenced by the choice of material of the conduct member carrier, but are predominantly dependent on the insulation radius. The minimum insulation resistance between contact member 211c and any other contact member is in embodiments 10 TΩ or more. Thus, a signal transmitted through contact member 211c is the least impaired by influences from electric signals or power transmitted through contact members 211a and 211b.

FIG. 4 shows a perspective view on an assembly comprising a connector element and a printed circuit board in a view from a back side of the connector element. Connector element 21 comprises contact member carrier 212, which is received inside a connector element housing 216, and locking sleeve 24. Connector element housing 216 comprises a radial groove 217 on its backside, in which a lug 215 of the contact member carrier is received. This ensures that the contact member carrier 212 can be mounted inside the connector element housing 216 in one orientation relative to the connector element housing only. The contact members extend axially through the contact member carrier and project from the back face of contact member carrier 212 with projecting sections 214a of contact members 211a, 214b of contact members 211b, and 214c of contact member 211c. Projecting sections 214b are not visible in the present depiction, as they are located underneath and hidden by printed circuit board 30. Connector element housing 216 comprises two pairs of axially extending lugs 219. The pairs of lugs are arranged on opposite sides of connector element housing 216. The lugs 219 of each pair of lugs have a space between them which is dimensioned and configured to receive the thickness of the printed circuit board 30 therebetween. Thereby, the lugs 219 can be used to establish an electrical connection between the PCB 30 and the connector element housing 216, which is useful for example to maintain the connector element housing 216 at a ground potential. Further, the lugs 219 can align and fixate the printed circuit board 30. Printed circuit board 30 itself comprises a circuit component 31, for instance an analog-digital converter component, on a surface of the printed circuit board. The printed circuit board further comprises conductor paths 32a, 32b and 32c, wherein conductor paths 32b are located on the invisible side of printed circuit board 30 in the present depiction. Projecting sections 214a and 214c of connector elements 211a and 211b project in an array from the back face of contact member carrier 212. Projecting sections 214b, which are not visible in the present description, project in a second array from the back face of contact member carrier 212. Said two arrays are arranged and configured such that a clear space is provided between the projecting sections in the two arrays, in which the printed circuit board can be received. In particular, the projecting sections in each array have a common tangent facing the other array, wherein the mutually facing tangents to the projecting sections in each array of parallel to each other. The clear space is dimensioned and configured such that the printed circuit board is received between the projecting sections in the two arrays in a fit. For instance, the distance between the common tangents of the projecting sections in one array facing the other array may be more than or equal to one times the thickness of the printed circuit board and less than or equal to 1.2 times the thickness of the printed circuit board, and may in even more particular embodiments correspond to more than or equal to 1.05 times the thickness of the printed circuit board and less than or equal to 1.1 times the thickness of the printed circuit board. The projecting sections of the contact members are arranged in close proximity to the surfaces of the printed circuit board and may thus be directly soldered to respective conductor paths on the surface of the printed circuit board. As can be seen from the depiction of FIG. 4, printed circuit board 30 comprises, on the side of the printed circuit board visible in the depiction, conductor paths 32a configured to be connected to projecting sections 214a and conductor path 32c configured to be connected to projecting section 214c. The conductor paths 32a and conductor path 32c are arranged such that they may be brought in registry with projecting sections 214a and 214c. The skilled person will readily appreciate that on the side of the printed circuit board not visible in the present depiction further conductor paths are arranged which may be brought into registry with the projecting sections of contact members 211b at the same time as conductor paths 32a and conductor path 32c are in registry with projecting sections 214a and 214c of contact members 211a and 211c. Projecting section 214c of contact member 211c, which has the largest insulation radius, is in contact with a conductor path 32c configured for receiving an analog measurement signal, such as, for instance, the signal from a pH measurement electrode. Conductor path 32c may in particular be configured for transmitting an analog measurement signal to circuit component 31.

By virtue of groove 217 of connector element housing 216, and lug 215 of contact member carrier 212 being received therein, it can be guaranteed that the clear space between the arrays of contact member projecting sections is aligned with the spaces provided between each pair of lugs 219 of the connector element housing. Thus, printed circuit board 30 can be held by lugs 219 and being received in the clear space between the arrays of projecting sections, for instance to facilitate soldering the projecting sections of the contact members to the respective conductor paths on the printed circuit board.

Moreover, connector element housing 216 comprises a circumferentially extending groove 218 configured for receiving and O-ring, as will be shown in more detail below.

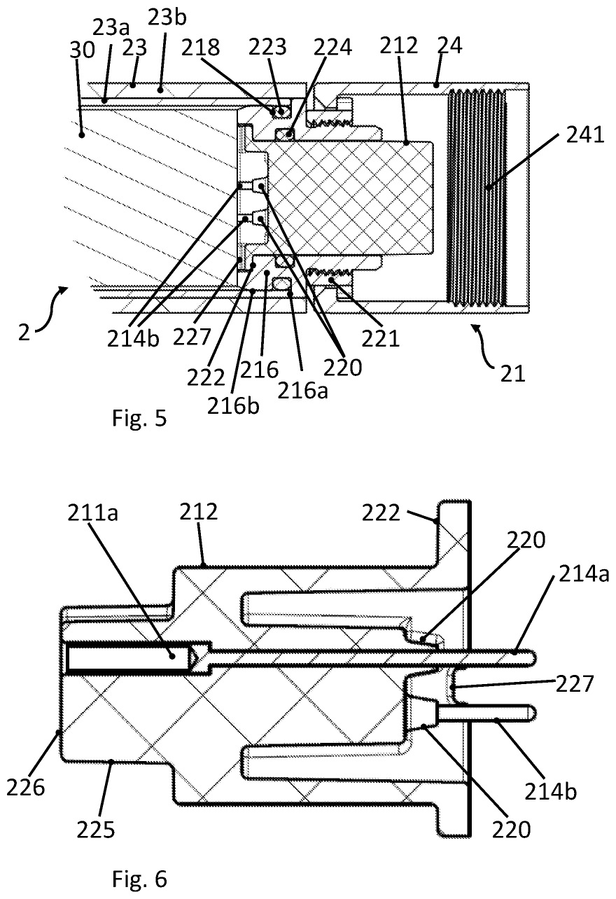

FIG. 5 shows a longitudinal section through sensor head 2, wherein also the printed circuit board 30 is cut between its two surfaces. As can be seen, connector element housing 216 comprises an inner circumferential groove with an O-ring 224 provided therein, while an O-ring 223 is provided in outer circumferential groove 218. Contact member carrier 212 is received within connector element housing 216 by pushing the contact member carrier 212 into housing 216 until it abuts at shoulder 222. O-ring 224 effects sealing between contact member carrier 212 and connector element housing 216. Further, a back section of connector element housing 216 is received within housing 23 of sensor head 2. Housing 23 and connector element housing 216 comprise a pair of matching shoulders, such that housing 23 can axially be pushed towards connector element 21 until the pair of matching shoulders abut each other. O-ring 223, which is received in radially outer groove 218 of connector element housing 216, effects sealing between the housing 23 and the connector. Furthermore, an abutment member 221 is screwed onto a front section of connector element housing 216. Locking sleeve 24 is axially displaceable received on a sleeve section of abutment member 221. Axial displacement of locking sleeve 24 is restricted by a forward pointing shoulder of connector element housing 216 and a backward pointing shoulder of abutment member 221. Locking sleeve 24 is thus secured to the other elements of connector element 21.

Housing 23 and locking sleeve 24 preferably are or comprise metallic members and serve as electromagnetic shielding elements shielding signals transmitted through connector element 21, and transmitted and processed on printed circuit board 30, from external interferences. In the embodiment disclosed in FIG. 5, the housing 23 comprises an electrically conducting inner tube 23a and an electrically insulating outer tube 23b. The connector element housing 216 comprises a second shoulder 216a onto which the inner tube 23a abuts in the assembled state. In addition, the connector element housing 216 comprises a radial contact surface 216b, along which the housing 23 is pushed during the mounting. The extent of the outer tube 23b is such that it surrounds the second shoulder 216a of the connector element housing 216 in radial direction when the inner tube 23a abuts to the second shoulder 216a in axial direction. The abutment and the contact to the radial contact surface 216b of the connector element housing 216 establish an electrical connection between the connector element housing 216 and the inner tube 23a and therefore extends the EMC shield.

As can further be seen, but will better be appreciated from the depiction in FIG. 6, collars 220 extend from the back face of the contact member carrier and surround the projecting sections of the contact members along a part of their longitudinal extents. These collars also serve to increase the distance for creeping currents between the projecting sections. Moreover, a recess 227 is provided on the back face of the contact member carrier and aligned with the clear space between the projecting sections of the contact members. Recess 227 is configured to receive the thickness of the printed circuit board, such that, if due to tolerances during manufacturing, parts of the printed circuit board the circuit board extend beyond the nominal dimension, the resulting protection can be received within the recess. Recess 227, thus, allows for increased tolerances in manufacturing the printed circuit board.

FIG. 6 shows a longitudinal section through contact member carrier 212. As is seen, contact member 211a is a socket-type contact member, having a socket-type opening adjacent to and accessible from the front face 226 of contact member carrier 212, and otherwise extends as a pin through contact member carrier 212, which projects from the back side of contact member carrier 212 as contact member projecting section 214a. As was outlined above, collars 220 extend from the back face of contact member carrier 212 and surround the projecting sections, of which only one projecting section 214a and one projecting section 214b are visible in the present depiction, along part of their longitudinal extents. As will be appreciated by virtue of FIG. 4, and the description thereto, it is intended that the printed circuit board shall be received in a clear space located between projecting sections 214a and 214b, wherein the clear space extends perpendicular to the drawing plane. Recess 227 on the back side of contact member carrier 212 extends perpendicular to the drawing plane between projecting sections 214a and 214b and is aligned with the clear space.

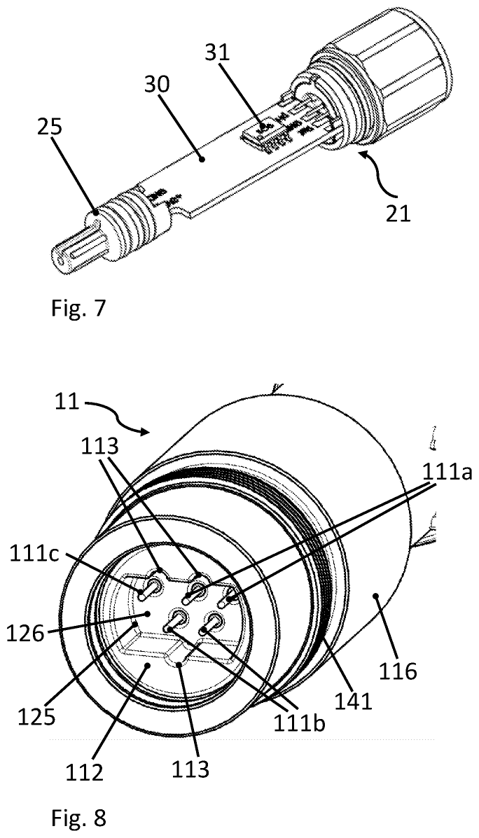

FIG. 7 depicts a sensor head with the housing removed. Printed circuit board is connected to connector element 21 at a front end of the printed circuit board. Contact members of connector element 21 are connected to the printed circuit board through their projecting sections, which are directly soldered to the respective conductor paths at the front end of the printed circuit board. A pluggable connector 25 is connected to a back end of printed circuit board 30. Contact members of pluggable connector 25 may also be directly soldered to respective conductor paths provided at a second end of printed circuit board 30. Printed circuit board 30 may, for one example, receive analog measurement signals from connector element 21 and provide said analog input to circuit component 31. Circuit component 31 may be an analog-digital converter and configured to process the analog input received from connector element 21 and generate a digital output, which is transmitted to pluggable connector 25. A counterpart pluggable connector may be plugged to pluggable connector 25 and the digital output be transferred to a data acquisition and/or data processing system.

FIG. 8 shows the counterpart connector element 11 to connector element 21, which is outlined in much detail above. Contact member carrier 112 comprises a socket 125, wherein the front face 126 of contact member carrier 112 is recessed within socket 125. Socket 125 is configured to receive plug structure 225. Socket 125 comprises coding structures 113 complementary to coding structures 213, arranged on its inner circumferential surface or inner circumference. While in the present examples positive, i.e., protruding, coding features are provided on the plug structure of connector element 21 and negative, i.e., recessed coding features are provided in socket 125, the skilled person will readily appreciate that protruding coding features may be provided on the inner circumference of socket 125 while recessed coding features may be provided on plug structure 125 of connector element 21. It is also possible that protruding as well as recessed coding features may be provided on the circumferential surfaces of socket 125 of connector element 11 and plug structure 225 of connector element 21. Important, however, is that for each protruding coding feature an axially extending recessed counterpart coding feature is provided on the counterpart connector element. Moreover, connector element 11 comprises pin-type contact members 111a, 111b and 111c projecting from front face 126 of contact member carrier 112, or connector element 11, respectively. Pin-type contact members 111a, 111b and 111c are arranged on front face 126 such that each pin-type contact member matches a socket-type contact member of connector element 21, and further pin-type contact members 111a, 111b and 111c are configured to fit into the socket-type conduct members to make electric contact. It is understood that it might also be possible that the pin-type contact members are provided on the front face 226 of connector element 21, and the socket-type contact members are provided in the front face 126 of connector element 11. Also, each of the connector elements 11, 21 may be provided with a combination of pin-type contact members and socket-type contact members. However, it is mandatory that for each pin-type contact member provided on one of the connector elements a matching socket-type contact member is provided on the counterpart connector element. It is, however, understood that pin-type contact members arranged inside a socket, like for instance socket 125, are largely protected against mechanical influences, while pin-type conduct members protruding from the front face of a plug structure, like plug structure 225 of connector element 21, are exposed and thus vulnerable to damage.

Further, connector element 11 comprises a connector element housing 116 in which contact member carrier 112 is received. Thread 141 is provided on the outside of connector element housing 116. Thread 141 is configured to engage thread 241 of locking sleeve 24. Thus, connector elements 11 and 21 can be mechanically locked with each other in that locking sleeve 24 is moved forward towards connector element 11 and screwed onto locking thread 141.

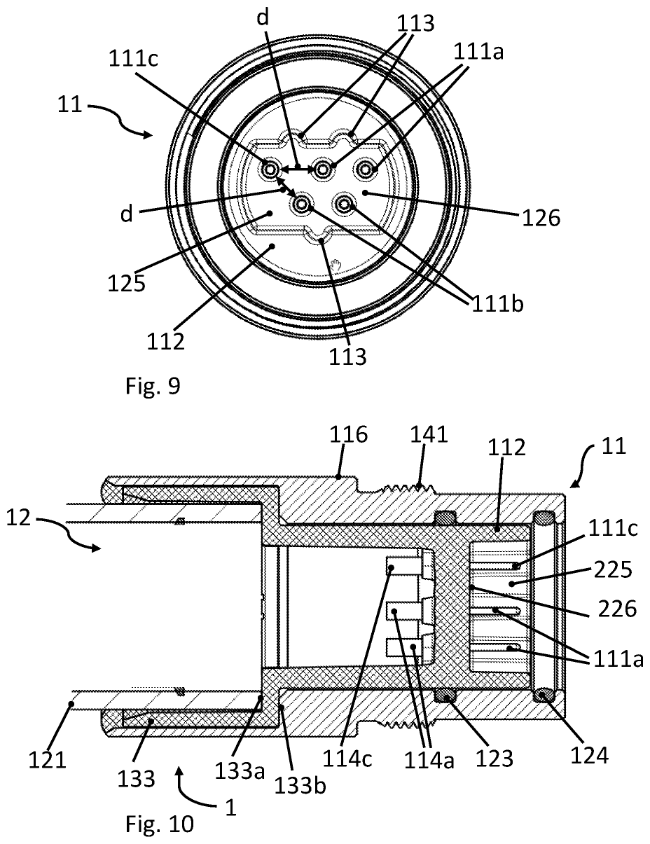

FIG. 9 shows a plain view onto the recessed front face 126 of contact member carrier 112. In analogy to the depiction of FIG. 3, one of the contact members, namely contact member 111c, has an insulation radius d which is larger than the insulation radius of any other contact member 111a and 111b. The arrangement of contact members 111a, 111b and 111c on the front face 126 is mirrored compared to the arrangement of contact members 211a, 211b and 211c on front face 226 shown in FIG. 3. Hence, when plug structure 225 of connector element 21 is received within socket 125 of connector element 11, in the right orientation, such that protruding coding structures 213 of connector element 21 match and are received within recessed coding structures 113 of connector element 11, pin-type contact members 111a match and are received within socket-type contact members 211a, pin-type contact members 111b match and are received within socket-type contact members 211b and pin-type contact member 111c matches and is received within socket type contact member 211c.

A longitudinal section of an exemplary sensor assembly comprising a sensor 12 and a connector element 11 is shown in FIG. 10. The sensor, in the shown exemplary, however non-nonlimiting, embodiment is a pH sensor. A glass sheathing 121 of the pH sensor is received inside a specifically designed section on a back side of the contact member carrier. Other elements and the function of the pH sensor are described elsewhere and known to the person having ordinary skill in the art. As noted above, contact member carrier 112 is received within connector element housing 116. An O-ring 123 is received in a circumferential groove on the inner diameter of the connector element housing 116. O-ring 123 provides sealing between contact member carrier 112 and connector element housing 116. A further O-ring 124 is provided in a further circumferential groove on the inner diameter of connector element housing 116 and in front of contact member carrier 112 in the direction in which the plug structure of connector element 21 is to be inserted into socket 225 in the contact member carrier 112 of connector element 11. Said O-ring provides for sealing between connector element housing 116 of connector element 11 and connector element housing 216 of connector element 21 and prevents liquid from penetrating into the joint between contact member carriers 112, and 212. Contact members 111a, 111b and 111c, of which only contact members 111a and 111c are visible in the present depiction, extent through contact member carrier 112 and project from a back face of contact member carrier 112 with projecting sections 114, of which only projecting sections 114a and 114c are visible in the current depiction. As noted above, contact member 111c, and projecting section 114c, have an insulation radius which is larger than that of any of the other contact members and respective projecting sections. Contact member 111c and projecting section 114c have, in embodiments, an insulation resistance of 10 TΩ to any of the other contact members and projecting sections. Thus, the measurement signal from the sensor may be connected to and transmitted by contact member 111c. In the shown exemplary embodiment, in particular the pH measurement electrode may be connected to a projecting section 114c.

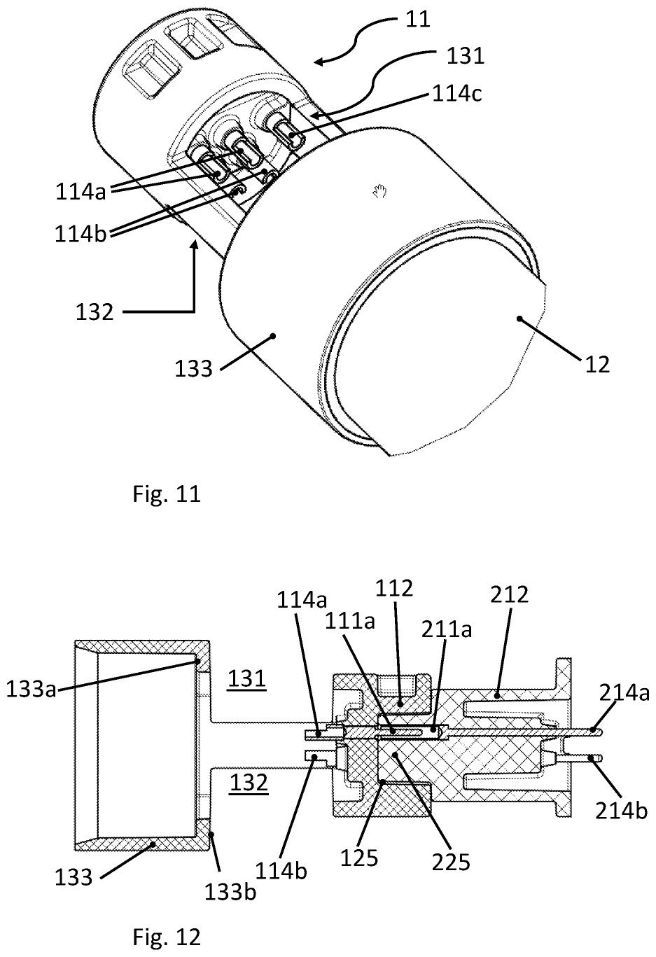

As shown in FIG. 11, the contact member carrier 112 has windows 131 and 132 around projecting sections 114a, 114b and 114c. The windows 131, 132 are arranged such that a number of projecting sections of contact members 114a, 114b, 114c are accessible side by side through each window. In the shown example, projecting sections 114a and 114c are accessible through window 131, while window 132 is provided on the opposite side to enable access to projecting sections 114b. The projecting sections are thus easily accessible for soldering wires and other connectors thereto. In embodiments, the projecting sections of the contact members are shaped as half-pipes, with the open side pointing towards the respective window so as to facilitate making connections thereto by soldering. This is further facilitated by the presence of the mounting structure 133 for the sensor: The mounting structure 133 provides a surface to which the sensor can be mounted, for example by an adhesive. In the example shown in FIG. 11, the mounting structure 133 is a hollow cylinder which comprises an inner shoulder 133a at the end facing the projecting sections of the contact members. The mounting structure 133 is either mechanically connected to the contact member carrier 112 or part of it. In the preferred embodiment, which is also shown in FIGS. 10 and 11, the mounting structure 133 is part of the contact member carrier 112. During production, the sensor can be mounted to the contact member carrier 112 by pushing it into the mounting structure 133 until it reaches the inner shoulder 133a and fixing it in this position with an adhesive. Once this mechanical connection is established, the electrical connections can be established through the windows 131, 132. This reduced the mechanical stress on the electrical connections both during assembly and later during use of the sensor assembly. Once the mechanical and electrical connections are assembled, a connector element housing 116 can be mounted by pushing it over the contact member carrier 112. In the illustrated and preferred embodiment, which is best seen in FIG. 10, the mounting structure 133 comprises an outer shoulder 133b onto which the connector element housing 116 abuts. The connector element housings 116 covers the windows 131 and 132.

FIG. 12 shows how contact member carriers 112 and 212 are joined to each other in a system comprising the two connector elements exemplarily shown in the above description. The connector elements, as outlined in detail above, in turn comprise contact member carriers 112 and 212. It is seen how plug structure 225 of contact member carrier 212 is received inside the socket of contact member carrier 112. Pin-type contact member 111a of connector element 11 is received with socket-type contact member 211a of connector element 21. Likewise, while not visible, all pin-type contact members are received in a counterpart socket-type contact member. Thus, signals and power may be transmitted from the projecting sections of the contact members of connector element 11, or elements connected thereto, respectively, to the projecting sections of the contact members of connector element 12, or elements connected thereto, respectively.

FIG. 12 further depicts windows 131 and 132 which provide easy access to the projecting sections of the projecting section 114a, 114b and 114c of the contact members 111a, 111b and 111c of connector element 11. Projecting sections 114a and 114c are accessible through window 131 while projecting sections 114b are accessible through window 132.

It should be noted that the connector having the plug structure on the contact member carrier may be provided on the sensor assembly and the connector having the socket in the contact member carrier may be provided on the sensor head.

While the subject matter of the disclosure has been explained by means of exemplary embodiments, it is understood that these are in no way intended to limit the scope of the claimed invention. It will be appreciated that the claims cover embodiments not explicitly shown or disclosed herein, and embodiments deviating from those disclosed in the exemplary modes of carrying out the teaching of the present disclosure will still be covered by the claims.

Reference signs list

| | |
|---|---|
| 1 | sensor assembly |
| 2 | sensor head |
| 11 | connector element |
| 12 | sensor |
| 21 | connector element |
| 23 | housing |
| 23a | Inner tube |
| 23b | Outer tube |
| 24 | locking sleeve |
| 25 | pluggable connector |
| 30 | printed circuit board |
| 31 | circuit component |
| 32a, 32b, 32c | conductor path |
| 111a, 111b, 111c | contact member |
| 112 | contact member carrier |
| 113 | coding structure |
| 114a, 114b, 114c | projecting section of contact |
| 116 | connector element housing |
| 121 | glass sheathing |
| 123 | O-ring |
| 124 | O-ring |
| 125 | socket |
| 126 | front face of a connector element or contact member |
| | carrier |
| 131,132 | windows |
| 141 | locking thread |
| 211a, 211b, 211c | contact member |
| 212 | contact member carrier |
| 213 | coding structure |
| 214a, 214b, 214c | projecting section of contact member |
| 215 | lug of contact member carrier |
| 216 | connector element housing |
| 216a | Second shoulder of the connector element housing |
| 216b | radial contact surface |
| 217 | radial groove of connector element housing |
| 218 | circumferentially extending groove |
| 219 | axially extending lug of connector element housing |
| 221 | abutment member |
| 222 | shoulder |
| 223 | O-ring |
| 224 | O-ring |
| 225 | plug structure |
| 226 | front face of a connector element or contact member |
| | carrier |
| 241d | internal thread of locking sleeve; locking thread |
| | insulation radius |

What is claimed is:

1. A connector element for a connector system, the connector element comprising:
at least three contact members for making electric contact; and
a contact member carrier, the contact member carrier having a front face;
wherein the contact members extend through the contact member carrier from the front face to a back face on a back side of the contact member carrier and project from the back side,
wherein each of the contact members has an insulation radius, said insulation radius being, when measured in a view onto the front face, a minimum clearance between outer boundaries of said contact member and a closest neighbouring one of the contact members;
wherein the insulation radius of at least one of the contact members exceeds the insulation radius of another one of the contact members.

2. The connector element of claim 1, wherein:
the insulation radius of one of the contact members exceeds the insulation radius of all other of the contact members.

3. The connector element of claim 1, wherein:
the contact member carrier comprises at least one of: collars extending from a back face and surrounding projecting sections of the contact members projecting from the back face along a part of their longitudinal extents, and recesses surrounding the projecting sections of the contact members.

4. The connector element of claim 1, wherein:
the contact members are arranged in two arrays extending across the front face.

5. An assembly comprising:
the connector element of claim 1; and
a printed circuit board, wherein the printed circuit board is received between the contact member projecting sections projecting from the back face;
wherein at least one of the contact member projecting sections is located on each face of the printed circuit board and directly soldered to a conductor path of the printed circuit board, thereby electrically connecting said at least one of the contact members to a conductor path of the printed circuit board.

6. The assembly of claim 5, wherein:
the connector element is the connector element of claim 4;
a clear space is provided between the projecting sections of the contact members of the first array and the contact members of the second array; and
the printed circuit board is arranged inside and extends across the clear space from the projecting sections of the contact members of the first array to the projecting sections of the contact members of the second array.

7. The assembly of claim 5, wherein:
a recess is provided on the back side of the contact member carrier and is configured to receive the printed circuit board.

8. The assembly of claim 5, wherein:
the printed circuit board has at least one contact path intended for transmitting an analog measurement signal to or from at least one circuit component arranged on the printed circuit board; and
one of:
at least one of the at least one of the contact members having the insulation radius which exceeds the insulation radius of another one of the contact members; and
the one contact member having the insulation radius exceeding the insulation radius of any other of the contact members is in electric contact with at least one of the at least one of the contact paths intended for transmitting an analog measurement signal to or from at least one circuit component.

9. An electronic device comprising:
the assembly according of claim 5, wherein a pluggable connector is attached to the printed circuit board opposite the connector element of the assembly; and
a housing extending between the connector element and the pluggable connector and encapsulating the printed circuit board.

10. A sensor assembly comprising:
a sensor; and
the connector element of claim 1;
wherein a signal line of the sensor through which an analog measurement signal is provided is in electrical connection with one of the at least one of the contact members having the insulation radius which exceeds the insulation radius of another of the contact members or the one contact members which has the insulation radius exceeding the insulation radius of any other of contact members.

11. The sensor assembly of claim 10, wherein:
the contact member is the contact member of claim 2;
the sensor is a pH-sensor comprising a pH measurement electrode for providing a signal caused by a measured solution, a pH reference electrode for providing a signal caused by a reference electrolyte, and a thermocouple; and
the pH measurement electrode is connected to the one contact member which has the insulation radius exceeding the insulation radius of any other of the contact members, and other of the contact members are in connection with the reference electrode, a grounding connection, and the thermocouple.

12. A connector system comprising:
two of the connector elements of claim 1, wherein a first one of the connector elements comprises the contact members comprising at least one of: at least one pin-type contact member projecting from the front face, and at least one socket-type contact member comprising a socket accessible from the front face, and wherein a second one of the connector elements comprises the contact members which are arranged on the front face of the contact member carrier of the second connector element and are shaped and arranged complementary to the contact members of the first connector element.

13. The connector system of claim 12, wherein:
the contact member carrier of a first one of the connector elements comprises a plug structure;
the front face is provided on the plug structure;
the contact member carrier of a second one of the connector elements comprises a socket;
the front face is recessed within the socket;
the plug structure and the socket have complementary cross sections such that the plug structure is receivable inside the socket;
the plug structure and the socket are configured to provide a sealing arrangement with each other when the plug structure is received inside the socket; and
contact between the contact members of the first connector element and the contact members of the second connector element is established when the plug structure is received within the socket.

14. The connector system of claim 13, wherein:
the plug structure comprises at least one coding structure on its outer circumference and the socket comprises at least one coding structure on its inner circumference; and
said coding structures of the socket and the plug are configured such that a projecting coding structure on one of the plug structure and the socket is receivable within a recessed coding structure in the other one of the plug structure and the socket when the plug structure is receivable within the socket in an orientation in which the complementary contact members of the first and second connector elements match each other.

15. A method for manufacturing the electronic device of claim 9, the method comprising:
providing a printed circuit board;
providing the connector element of claim 1, wherein the projecting sections of the contact members are arranged in two rows leaving a clear space between the rows, the clear space configured and dimensioned to receive the printed circuit board therein with the projecting sections adjacent the two faces of the printed circuit board;
inserting a first end of the printed circuit board into the clear space such that the projecting sections are in registry with conductor paths of the printed circuit board and directly soldering the projecting sections to the respective conductor paths with which they are in registry;
connecting one of a pluggable connector and a sensor to a second end of the printed circuit board, wherein a first one of the members thus connected to the printed circuit board comprises a cylindrical outer diameter thereof and a sealing member arranged on the cylindrical outer diameter, and a second one of the members connected to the printed circuit board comprises an end stop for a housing;
providing a housing comprising a cylindrical inner diameter dimensioned to achieve sealing with the sealing member provided on the first one of the members connected to the printed circuit board, and
axially displacing the housing over the first one of the members connected to the printed circuit board towards the second one of the members connected to the printed circuit board until the housing engages the end stop.
